(19) United States
(12) Patent Application Publication
(10) Pub. No.: US 2023/0221718 A1
(43) Pub. Date: Jul. 13, 2023

(54) FLIGHT VEHICLE CONTROL APPARATUS, METHOD AND PROGRAM

(71) Applicant: NEC Corporation, Minato-ku, Tokyo (JP)

(72) Inventor: Keiichi OHSHIO, Tokyo (JP)

(73) Assignee: NEC Corporation, Minato-ku, Tokyo (JP)

(21) Appl. No.: 18/010,973

(22) PCT Filed: Jun. 16, 2021
(86) PCT No.: PCT/JP2021/022796

§ 371 Date: Dec. 16, 2022

(30) Foreign Application Priority Data
Jun. 25, 2020 (JP) 2020-109729

(51) Int. Cl. G05D 1/00; B63B 79/40; H04W 4/40; G06V 20/17; B64U 10/00

(52) U.S. Cl. CPC G05D 1/0027; B63B 79/40; H04W 4/40; G06V 20/17; B64U 10/00; B64U 2101/20

(57) ABSTRACT

In order to provide a flight vehicle control apparatus, a method and a program for an automatic navigation ship navigating in a vicinity of a harbor, a flight vehicle control apparatus according to one example embodiment of the present invention includes calculation means for calculating a first radio wave range required for navigation of a ship capable of automatic navigation using mobile communications, based on a shape of a harbor, measurement means for measuring a second radio wave range in which a radio wave from a base station on a ground and disposed in the harbor reaches; and determination means for determining an arrangement of one or more flight vehicles equipped with a base station function such that a region that is within the first radio wave range and is not included in the second radio wave range falls within a third radio wave range of the one or more flight vehicles.

### TECHNICAL FIELD

The present invention relates to a flight vehicle control apparatus, a method and a program.

### BACKGROUND ART

Conventionally, communication networks at sea are provided mainly by satellite communications, and it is also expected that the satellite communications will be mainly used for automatic navigation ships. However, the satellite communications are unstable and unsuitable for communications that require advanced controls in the vicinity of a harbor such as control in entry and departure for ships, control for avoiding collision between ships, and centralized control for avoiding congestion of ships.

Radio waves from base stations on the ground may be used for such advanced controls. However, as illustrated in FIGS. 2A and 2B, depending on the shape of the harbor and the surrounding landform thereof, there may arise a situation in which a ship does not fall within the coverage of radio waves from base stations on the ground. For example, as illustrated in FIG. 2A, there is a case in which radio waves from base stations do not reach a ship navigating at sea because the base stations are installed on a precipitous cliff. For example, as illustrated in FIG. 2B, since an entrance of a harbor is far from base stations on the ground, there is a case in which radio waves of the base stations do not reach a ship located near the entrance of the harbor. Furthermore, as illustrated in FIGS. 3A and 3B, a radio wave range required varies depending on the shape of the harbor and the navigation conditions of ships in the vicinity of the harbor, and therefore, there is a case in which ships cannot be covered only by base stations on the ground each having a fixed radio wave range. For example, in the case of FIG. 3A, in a time period during which the number of ships entering and leaving the harbor is small, since congestion rarely occurs near the entrance of the harbor, it is sufficient to provide a radio wave range covering the inside of the harbor. In the case of FIG. 3B, for example, since the entrance of the harbor is narrow and congestion is expected to occur frequently, it is necessary to control the order of entry to the harbor and exit from the harbor near the entrance, and a radio wave range covering the outside of the harbor is required.

PLT 1 discloses that the deployment of mobile base stations is dynamically changed according to a reception state of radio waves from a radio terminal.

### CITATION LIST

### Patent Literature

[PTL 1] JP 2019-033409 A

### SUMMARY

### Technical Problem

However, in the method disclosed in PLT 1, it takes a long time for radio waves to reach ships in the harbor. In addition, in the method in PLT 1, radio waves received from general ships not supporting automatic navigation are also used as a reference for determining the arrangement of the mobile base stations. Therefore, the communication range of the mobile base stations may unnecessarily cover ships not supporting automatic navigation control. For this reason, extra mobile base stations are arranged, resulting in an increase in cost.

An example object of the present invention is to provide a flight vehicle control apparatus, a method and a program that are applied for an automatic navigation ship navigating in a vicinity of a harbor.

### Solution to Problem

A flight vehicle control apparatus according to one example aspect of the present invention is characterized by including: calculation means for calculating a first radio wave range required for navigation of a ship capable of automatic navigation using mobile communications, based on a shape of a harbor; measurement means for measuring a second radio wave range in which a radio wave from a base station on a ground and disposed in the harbor reaches; and determination means for determining an arrangement of one or more flight vehicles equipped with a base station function such that a region that is within the first radio wave range and is not included in the second radio wave range falls within a third radio wave range of the one or more flight vehicles.

A program according to one example aspect of the present invention is characterized by causing a computer to function as the above-described flight vehicle control apparatus.

A method according to one example aspect of the present invention is characterized by including: a calculating step for calculating a first radio wave range required for navigation of a ship capable of automatic navigation using mobile communications, based on a shape of a harbor; a measuring step for measuring a second radio wave range in which a radio wave from a base station on a ground and disposed in the harbor reaches; and a determining step for determining an arrangement of one or more flight vehicles equipped with a base station function such that a region that is within the first radio wave range and is not included in the second radio wave range falls within a third radio wave range of the one or more flight vehicles.

### Advantageous Effects of Invention

According to the present invention, it is possible to provide the flight vehicle control apparatus, the method and the program that are applied for the automatic navigation ship navigating in the vicinity of the harbor. Note that, according to the present invention, instead of or together with the above effects, other effects may be exerted.

### BRIEF DESCRIPTION OF THE DRAWINGS

FIG. 1 is a diagram illustrating an outline of a drone control system according to one example embodiment.

FIG. 2A is a diagram illustrating a situation in which radio waves of base stations on the ground do not reach an automatic operation ship.

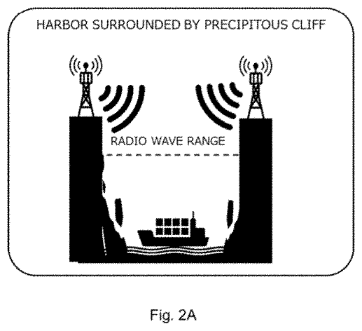

FIG. 2B is a diagram illustrating a situation in which radio waves of base stations on the ground do not reach an automatic operation ship.

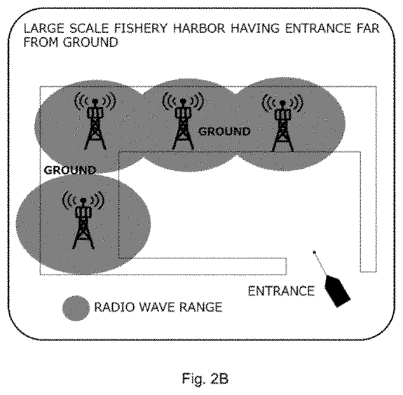

FIG. 3A is a diagram illustrating a radio wave range required for control in automatic operation ships.

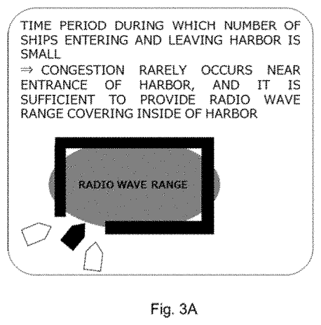

FIG. 3B is a diagram illustrating a radio wave range required for control in automatic operation ships.

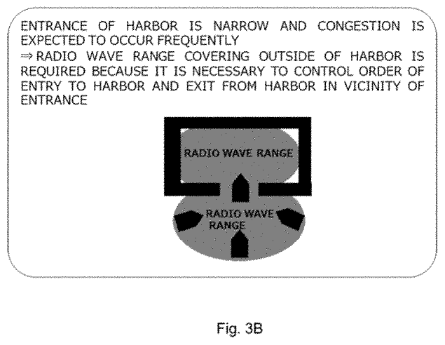

FIG. 4 is a diagram illustrating an overall configuration of a drone control system according to a first example embodiment.

FIG. 5 is a diagram illustrating a schematic configuration of a base station drone according to the first example embodiment.

FIG. 6 is a diagram illustrating a schematic configuration of a drone for location measurement according to the first example embodiment.

FIG. 7 is a diagram illustrating a schematic configuration of a drone control tower according to the first example embodiment.

FIG. 8 is a diagram illustrating a schematic configuration of an automatic operation ship according to the first example embodiment.

FIG. 9 is a diagram illustrating an initial arrangement of base station drones according to the first example embodiment.

FIG. 10 is a diagram illustrating a radio wave range required for a harbor according to the first example embodiment.

FIG. 11 is a flowchart for determining the initial arrangement of the base station drones according to the first example embodiment.

FIG. 12 is a flowchart for determining an optimal arrangement of the base station drones according to the first example embodiment.

FIG. 13 is a diagram explaining the optimal arrangement of the base station drones according to the first example embodiment.

FIG. 14 is a diagram explaining calculation of a ship density according to the first example embodiment.

FIG. 15 is a hardware configuration diagram of a computer according to the first example embodiment.

FIG. 16 is a diagram illustrating a schematic configuration of a drone control apparatus according to a second example embodiment.

### DESCRIPTION OF THE EXAMPLE EMBODIMENTS

Hereinafter, example embodiments of the present invention will be described in detail with reference to the accompanying drawings. Note that, in the Specification and drawings, elements to which similar descriptions are applicable are denoted by the same reference signs, and overlapping descriptions may hence be omitted.

Descriptions will be given in the following order.

1. Overview of Example Embodiments of Present Invention

2. First Example Embodiment
2.1. System Configuration
2.2. Operation Example
2.3. Hardware Configuration
2.4. Description of Advantageous Effects

3. Second Example Embodiment
3.1. System Configuration
3.2. Operation Example

### 1. Overview of Example Embodiments of Present Invention

First, an overview of example embodiments of the present invention will be described.

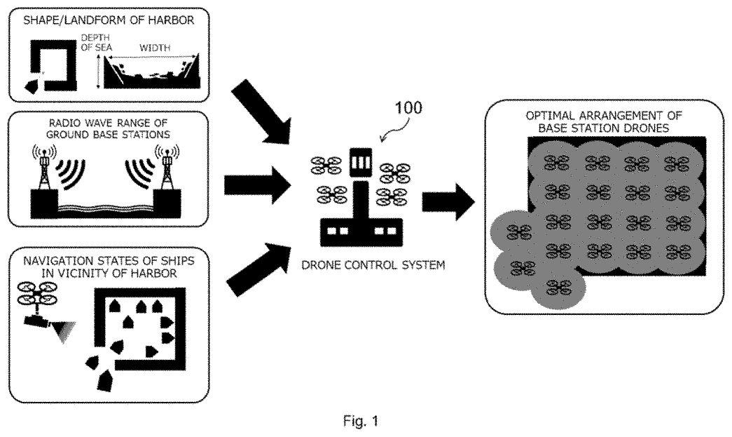

FIG. 1 is a diagram describing an overview of a drone control system according to one example embodiment. In one example embodiment of the present invention, a drone control system 100 is provided which realizes a communication network required for automatic navigation (hereinafter also referred to as automatic operation) using mobile communications of ships in the vicinity of a harbor by flying drones (hereinafter referred to as base station drones) each having a base station function. The drone control system includes a drone control tower. The drone control tower determines an optimal base station drone arrangement according to the shape of the harbor, a radio wave range formed by public base stations on the ground, and navigation states of ships in the vicinity of the harbor such that all ships (hereinafter referred to as automatic navigation ships or automatic operation ships) each having an automatic operation function and navigating in the vicinity of the harbor fall within a communication range (radio wave range) of base station drones, and the drone control tower controls the base station drones according to the determined base station drone arrangement. The drone is one example of flight vehicles, and may be an Unmanned Aerial Vehicle (UAV) or manned flight vehicle. Therefore, the drone control system is also referred to as a flight vehicle control system, and the drone control tower is also referred to as a flight vehicle control tower. The automatic navigation ship that navigates in the vicinity of the harbor may be, for example, an automatic navigation ship navigating the inside of the harbor, or an automatic navigation ship navigating between the inside of the harbor and the outside of the harbor.

Patterns providing a network include a pattern using an existing public 5G base station and using multi-hop communication relaying radio waves from a 5G base station on the ground, and a pattern using a local 5G base station provided in conjunction with a 5G core system. Either or both of these two patterns can be used depending on the installation state of public 5G base stations around the harbor.

A drone control system according to one example embodiment of the present invention has the following features.

(a) Base station drones utilize multi-hop communication to deliver radio waves from 5G base stations on the ground to automatic operation ships in the vicinity of the harbor via two or more drones.

(b) The drone control tower manages the arrangement of the base station drones, dynamically determines an optimal arrangement of the base station drones based on the shape of the harbor and the navigation states of ships in the vicinity of the harbor, and controls the flight of the base station drones so that 5G radio waves always reach the automatic operation ships in the vicinity of the harbor.

(c) Input information used by the drone control tower when determining the arrangement of the base station drones is limited to information from the automatic operation ships, and reception signals from general ships are not used. Since the optimal arrangement is determined by the optimal number of drones to be arranged, an extra base station drone is not arranged, and the cost is suppressed.

The above-described overview of the example embodiments of the present invention is described with reference to a specific example, and the following example embodiments of the present invention are not limited thereto.

### 2. First Example Embodiment

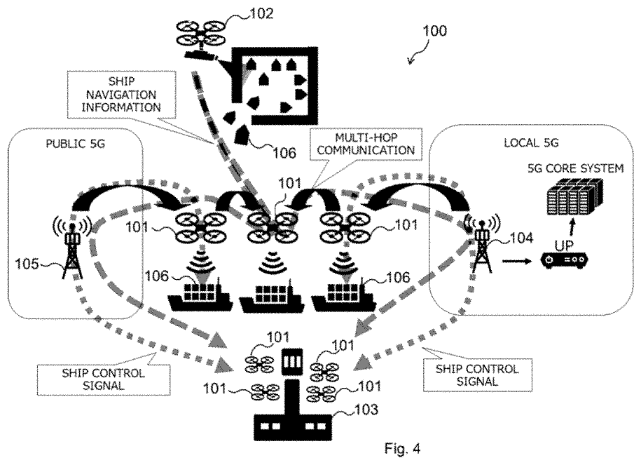

Next, a description will be given of a first example embodiment of the present invention with reference to FIGS. 4 to 14.

<2.1. System Configuration>

FIG. 4 illustrates an overall configuration of a drone control system according to the first example embodiment. The drone control system 100 includes base station drones 101, a drone 102 for location measurement, a drone control tower 103, a local 5G base station 104, and a public 5G base station 105. Each component of the drone control system will be described in detail below.

(1) Base Station Drone 101 The base station drone 101 is a drone equipped with a base station function of a wireless communication network such as 5G. The base station drone 101 serves as a relay station (repeater) for radio waves from base stations on the ground in multi-hop communication, and delivers radio waves from the base stations on the ground to automatic operation ships 106 existing in the vicinity of the harbor.

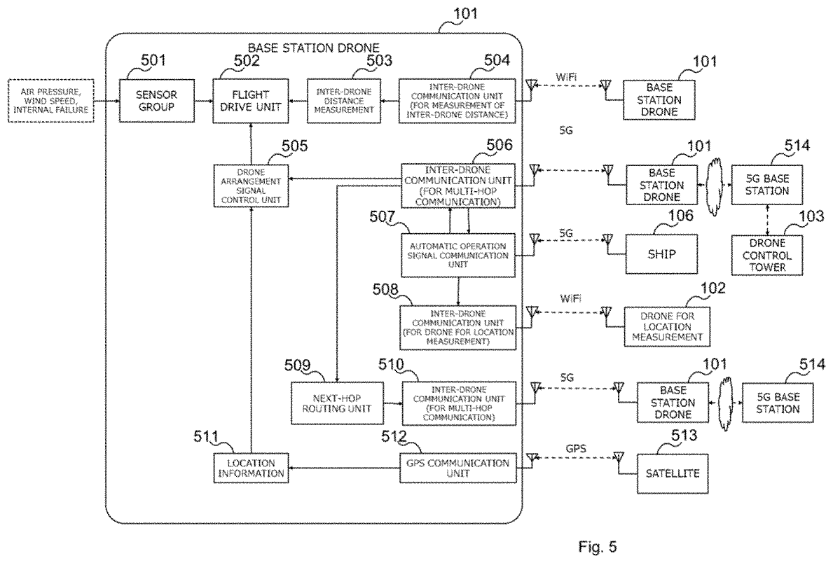

FIG. 5 is a functional block diagram of the base station drone according to the present example embodiment.

The base station drone 101 includes: a sensor group 501 for detecting air pressure, wind pressure, failure in the base station drone, and the like; a flight drive unit 502 including a propeller, a motor, and the like; an inter-drone distance measurement unit 503; an inter-drone communication unit 504 for measuring an inter-drone distance; a drone arrangement signal control unit 505; an inter-drone communication unit 506 for multi-hop communication, the inter-drone communication unit 506 performing multi-hop communication with the base station drone 101 communicating with a 5G base station 514; an automatic operation signal communication unit 507; an inter-drone communication unit 508 for communication with the drone for location measurement; a next-hop routing unit 509; an inter-drone communication unit 510 for multi-hop communication; a location information acquisition unit 511; and a Global Positioning System (GPS) communication unit 512 for communicating with a satellite 513 via the GPS.

(2) Drone 102 for Location Measurement

The drone 102 for location measurement is equipped with a high-precision camera, and captures the inside of the harbor and the vicinity of the harbor by using the high-precision camera. Further, the drone 102 for location measurement extracts image data including only the automatic operation ships from the captured image, and transmits the extracted image data to the drone control tower 103. The drone for location measurement is an example, and a vehicle for location measurement such as a UAV or manned vehicle equipped with a camera may be used for capturing.

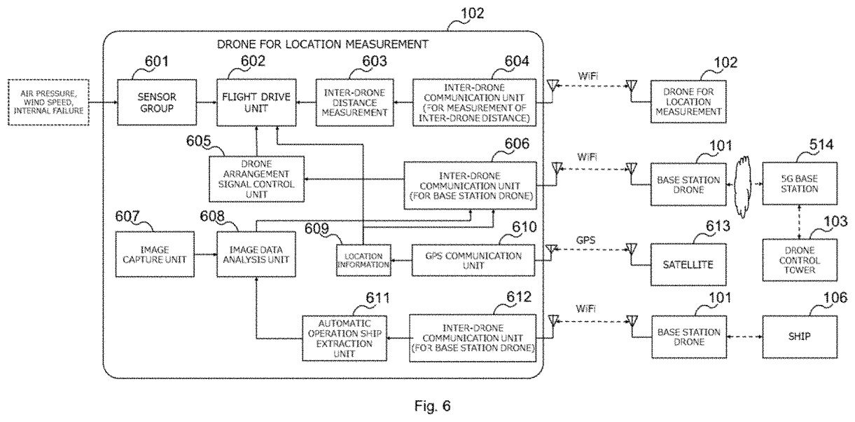

FIG. 6 is a functional block diagram of the drone for location measurement according to the present example embodiment.

The drone 102 for location measurement includes: a sensor group 601 for detecting air pressure, wind pressure, failure in the drone for location measurement, and the like; a flight drive unit 602 including a propeller, a motor, and the like; an inter-drone distance measurement unit 603; an inter-drone communication unit 604 for measuring an inter-drone distance between this unit and another drone for location measurement; a drone arrangement signal control unit 605; an inter-drone communication unit 606 for the base station drone; an image capture unit 607; an image data analysis unit 608; a location information acquisition unit 609; a GPS communication unit 610 for communicating with a satellite 613 via the GPS; an automatic operation ship extraction unit 611; and an inter-drone communication unit 612 for the base station drone.

(3) Drone Control Tower 103

The drone control tower 103 determines an optimal arrangement of the base station drones 101 based on a design drawing of the harbor and image data showing navigation states of the automatic operation ships existing the inside of the harbor and in the vicinity of the harbor, and centrally manages flight control of the base station drones 101. The drone control tower 103 determines, based on the image data showing the navigation states of the automatic operation ships, a range to be captured by the drone 102 for location measurement, and centrally manages flight control of the drone 102 for location measurement.

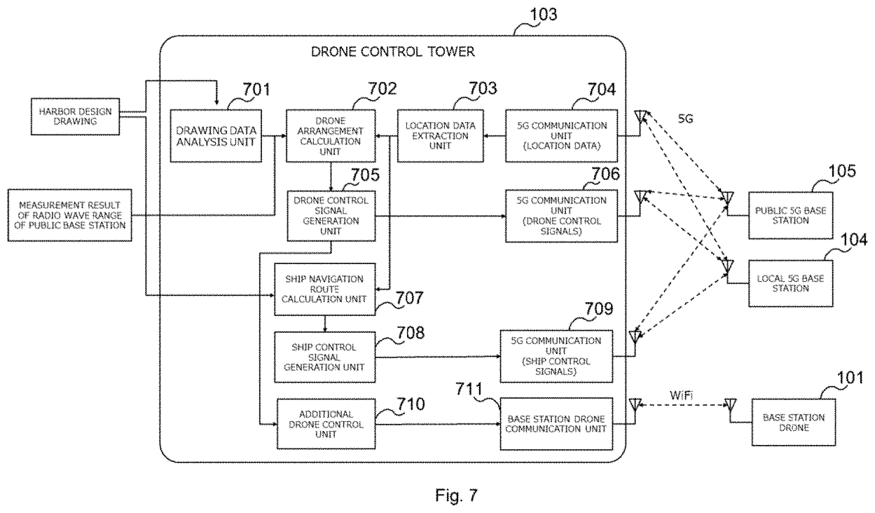

FIG. 7 is a functional block diagram of the drone control tower according to the present example embodiment.

The drone control tower 103 includes: a drawing data analysis unit 701; a drone arrangement calculation unit 702; a location data extraction unit 703; a 5G communication unit 704 for location data; a drone control signal generation unit 705; a 5G communication unit 706 for drone control signals, a ship navigation route calculation unit 707; a ship control signal generation unit 708; a 5G communication unit 709 for ship control signals; an additional drone control unit 710; and a base station drone communication unit 711. The drone control tower 103 is implemented as a drone control apparatus (or flight vehicle apparatus) having the above-described functions.

(4) Local 5G Base Station 104

A local 5G network provided by the local 5G base station 104 and the 5G core system is provided exclusively for users utilizing the drone control system according to one example embodiment of the present invention. Since the network control technology of the local 5G is a general 5G technology, a detailed description is omitted.

Since an advanced network is required for the automatic operation of the ship, the present example embodiment is described on the premise of 5G, but if the automatic operation control can be implemented in 4G or LTE, either of these networks may be used.

(5) Public 5G Base Station 105

The public 5G base station 105 is a 5G base station provided by a communication carrier.

Since an advanced network is required for the automatic operation of the ship, the present example embodiment is described on the premise of 5G, but if the automatic operation control can be implemented in 4G or LTE, either of these networks may be used.

The local 5G base station 104 and the public 5G base station 105 are collectively referred to as “base stations or 5G base stations”.

(6) Automatic Operation Ship 106

When the automatic operation ship 106 enters and leaves the harbor, the automatic operation ship 106 is steered through centralized control by the drone control tower 103 and controlled by a control signal from the drone control tower 103.

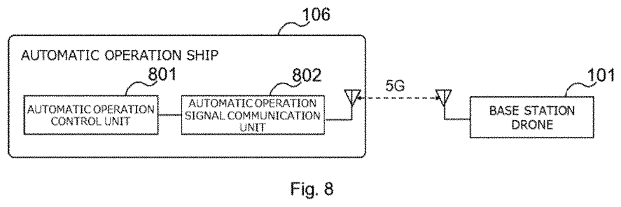

FIG. 8 is a functional block diagram of the automatic operation ship according to the present example embodiment.

The automatic operation ship 106 includes an automatic operation control unit 801, and an automatic operation signal communication unit 802. The present example embodiment is described on the assumption that automatic operation control technology for ships will be realized in the future.

Next, an application of communication and a route of the communication according to one example embodiment of the present invention will be described.

(1) Ship Control Signal

The ship control signal is transmitted from the drone control tower 103 to the automatic operation ship 106 through the following route.

The drone control tower—the 5G base station (public 5G or local 5G)—the base station drone (multi-hop communication)—the automatic operation ship

(2) Flight Control Signal (Base Station Drone 101)

The flight control signal for the base station drone 101 is transmitted from the drone control tower 103 to the base station drone 101 through the following route.

The drone control tower—the 5G base station (public 5G or local 5G)—the base station drone (multi-hop communication)—the base station drone

(3) Flight Control Signal (Drone 102 for Location Measurement)

The flight control signal for the drone 102 for location measurement is transmitted from the drone control tower 103 to the drone 102 for location measurement through the following route.

The drone control tower—the 5G base station (public 5G or local 5G)—the base station drone (multi-hop communication)—the drone for location measurement

(4) Image Data

The image data generated by the drone 102 for location measurement is transmitted from the drone 102 for location measurement to the drone control tower 103 through the following route.

The drone for location measurement—the base station drone (multi-hop communication)—the 5G base station (public 5G or local 5G)—the drone control tower

<2.2. Operation Example>

(1) Initial Arrangement of Base Station Drones

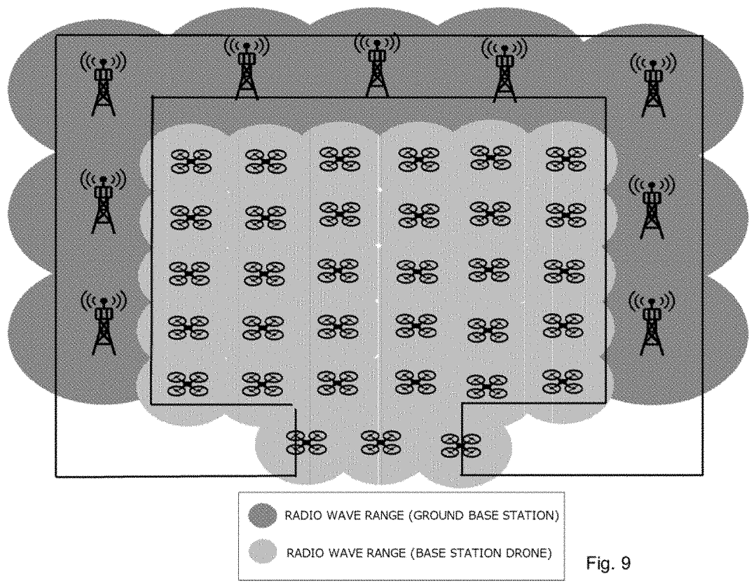

FIG. 9 illustrates an initial arrangement of base station drones according to the present example embodiment. As illustrated in the figure, one or more base station drones 101 are initially arranged such that the inside of the harbor is covered with radio waves of ground base stations or radio waves of the base station drones 101.

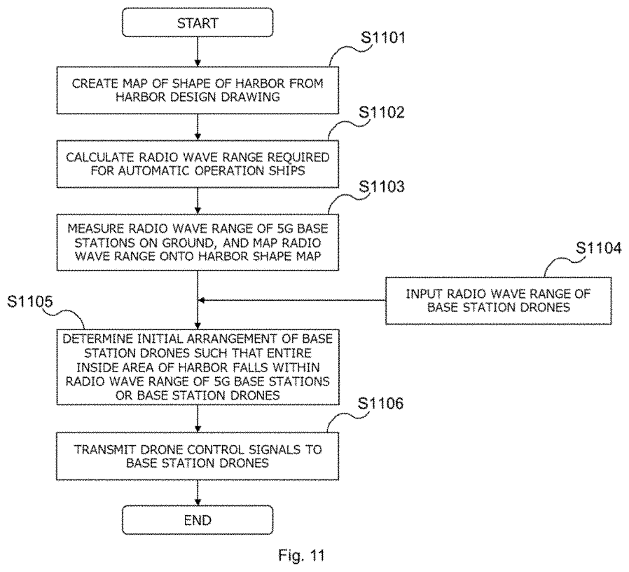

FIG. 11 is a flowchart for initially arranging the base station drones according to the present example embodiment. The initial arrangement of the base station drones is determined according to the flowchart. A detailed flow will be described below.

First, in S1101, the drawing data analysis unit 701 of the drone control tower 103 receives data, such as a design drawing of the harbor, which is input information on the shape of the harbor. The drawing data analysis unit 701 generates a map representing the shape of the harbor using the received data. The drawing data analysis unit 701 inputs to the drone arrangement calculation unit 702 data in which the shape of the harbor is expressed on a map (hereinafter also referred to as harbor shape map).

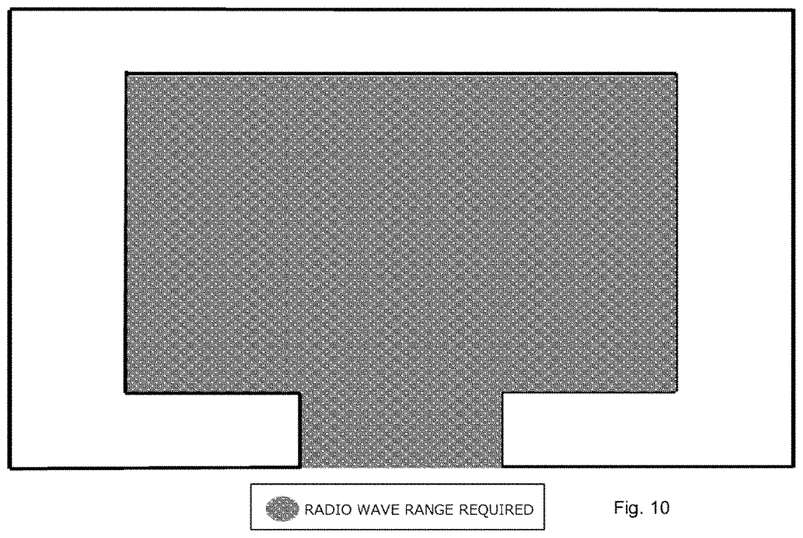

Next, in S1102, the drone arrangement calculation unit 702 uses the harbor shape map to calculate a radio wave range required for the automatic operation ships 106 in the inside area of the harbor and at an entrance of the harbor, as illustrated in FIG. 10. That is, the drone arrangement calculation unit 702 functions as calculation means for calculating the radio wave range required for the automatic operation ships 106.

Next, in S1103, the drone arrangement calculation unit 702 measures a radio wave range of the 5G base stations on the ground, and maps the measured radio wave range onto the harbor shape map. That is, the drone arrangement calculation unit 702 also functions as measurement means for measuring the radio wave range of the 5G base stations on the ground.

Next, when the radio wave range of the base station drones 101 is input in S1104, in S1105, the drone arrangement calculation unit 702 determines the initial arrangement of the base station drones 101, as illustrated in FIG. 9, such that a range in which the radio waves from the ground 5G base stations measured in S1103 reach is excluded from the radio wave range required for the inside area of the harbor calculated in S1102, and that the remaining area is covered with the base station drones. That is, the drone arrangement calculation unit 702 also functions as determination means for determining the initial arrangement of the base station drones 101 such that the entire inside area of the harbor falls within the radio wave range of the 5G base stations or the base station drones 101. The drone arrangement calculation unit 702 inputs data on the initial arrangement of the base station drones 101 to the drone control signal generation unit 705.

Next, in S1106, the drone control signal generation unit 705 generates drone control signals, and transmits the generated drone control signals to all the base station drones 101 requiring the drone control signals via the 5G communication unit 706. In this way, the base station drones 101 are initially arranged in the harbor as illustrated in FIG. 9.

If, after the initial arrangement of the base station drones 101 is determined, the automatic operation ship 106 cannot receive radio waves in the harbor and thus cannot perform the automatic operation control, the corresponding automatic operation ship 106 transmits an error signal and location information to the drone control tower 103 after arriving at the harbor (for example, after receiving radio waves from the ground base stations). The drone control tower 103 specifies a position where radio waves cannot be received in the harbor, based on the error signal and the location information. Then, the drone control tower 103 transmits a deployment correction request to the base station drones 101.

(2) Dynamic Arrangement Change of Base Station Drones

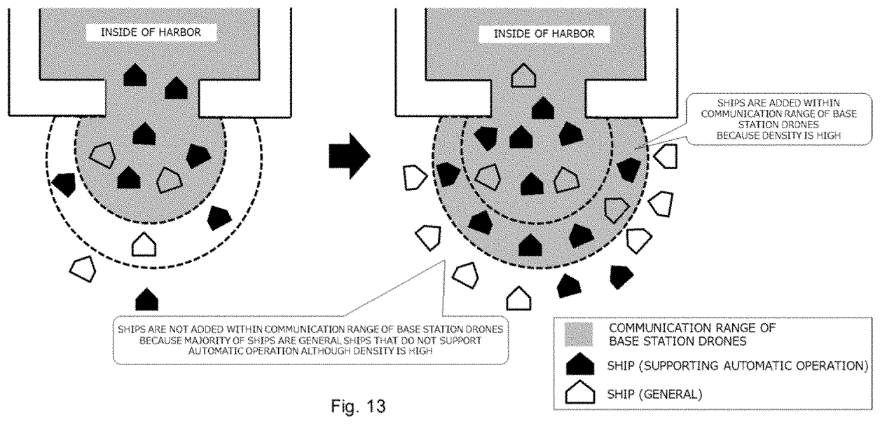

The drone control tower 103 dynamically changes the arrangement of the base station drones 101 in accordance with the respective navigation states of the automatic operation ships 106 in the vicinity of the harbor. Specifically, as illustrated in FIG. 13, a dense area having a high density (also referred to as a crowding degree) of the autonomous driving ships 106 is specified with respect to an area outside the harbor which was outside the radio wave range at the time of the initial arrangement of the base station drones 101. Then, one or more new base station drones 101 are added such that the dense area falls within the radio wave range of the base station drones 101. When the density becomes low and the radio wave of the base station drone 101 becomes unnecessary, the corresponding base station drone 101 covering the area is returned to the ground. In this way, the drone control tower 103 changes the radio wave range formed by the base station drones 101 according to the congestion state of the automatic operation ships 106. The one or more new base station drones 101 arranged in the vicinity of the entrance of the harbor can constitute a radio wave range which enables communication at least with an automatic operation ship navigating between the inside of the harbor and the outside of the harbor.

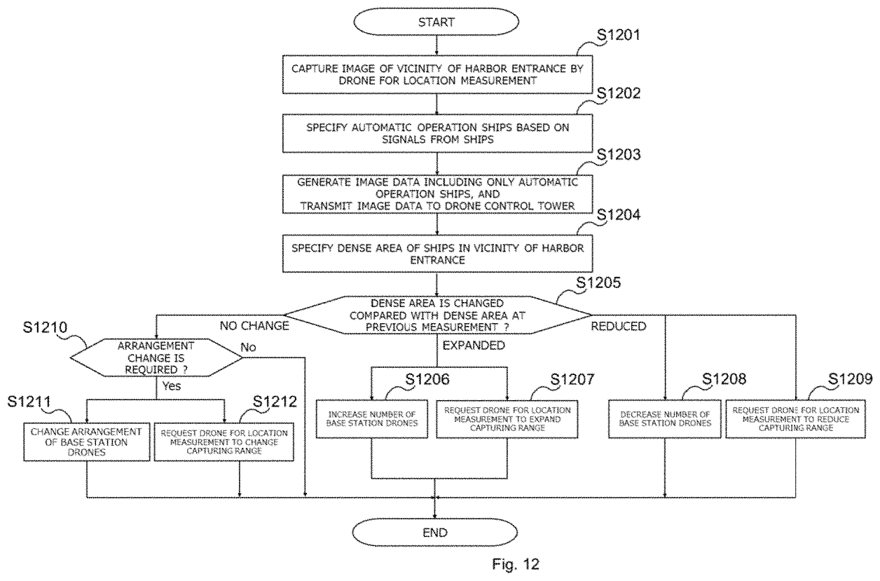

FIG. 12 is a flowchart for dynamically changing the arrangement of the base station drones according to the present example embodiment. The arrangement of the base station drones is changed according to the flowchart. A detailed flow will be described below.

First, in S1201, the image capture unit 607 of the drone 102 for location measurement captures an image of the vicinity of the entrance of the harbor, and inputs the image data to the image data analysis unit 608. The vicinity of the entrance of the harbor includes an area outside the harbor. The image may be a still image or a moving image. The initial capturing range is a range preset by a user.

Next, in S1202, based on location information request signals received from the automatic operation ships via the base station drones, the automatic operation ship extraction unit 611 specifies the automatic operation ships from the image data and pieces of location information of the automatic operation ships. Then, the automatic operation ship extraction unit 611 input information on the specified automatic operation ships to the image data analysis unit 608.

Next, in S1203, the image data analysis unit 608 generates, based on the image data input in S1201 and the information on the automatic operation ships specified in S1202, image data indicating the number of automatic operation ships and locations thereof, excluding general ships that do not support automatic operation. Then, the image data analysis unit 608 transmits the generated image data to the drone control tower 103.

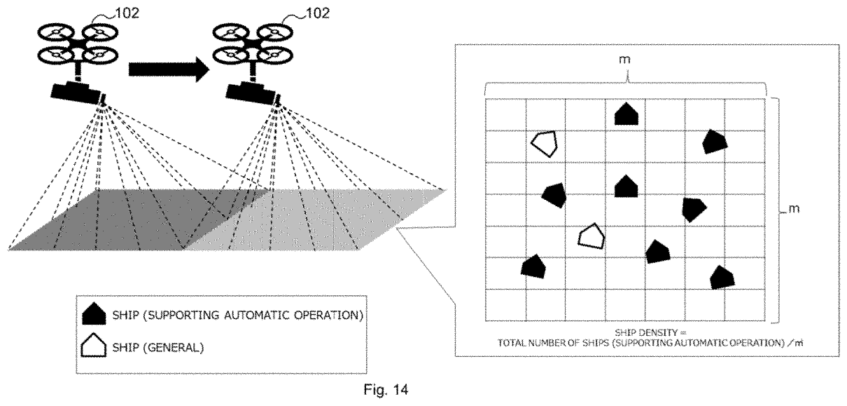

Next, in S1204, the drone arrangement calculation unit 702 of the drone control tower 103 calculates, based on the image data received, a ship density for automatic operation ships in the vicinity of the entrance of the harbor, as illustrated in FIG. 14. Then, the drone arrangement calculation unit 702 specifies a dense area in which the calculated density exceeds a predetermined threshold.

Next, in S1205, the drone arrangement calculation unit 702 compares the specified dense area with the dense area at the previous measurement, and determines whether the dense area is changed. In a case in which the dense area is changed and expanded, the process proceeds to S1206 and S1207.

In S1206, the drone arrangement calculation unit 702 increases the number of base station drones 101 such that the expanded dense area falls within the range of the base station drones. In S1207, the drone control tower 103 requests the drone 102 for location measurement to expand the capturing range.

On the other hand, in a case in which it is determined in S1205 that the dense area is changed so as to reduce the range thereof, the process proceeds to S1208 and S1209.

In S1208, the drone arrangement calculation unit 702 decreases the number of base station drones 101 for the reduced dense area. In S1209, the drone control tower 103 requests the drone 102 for location measurement to reduce the capturing range.

Further, in a case in which it is determined in S1205 that the dense area is not changed, the process proceeds to S1210.

In S1210, the drone arrangement calculation unit 702 determines whether it is required to change the arrangement of the base station drones 101. In a case in which it is determined that the arrangement change is required, the process proceeds S1211 and S1212.

In S1211, the drone arrangement calculation unit 702 changes the arrangement of the base station drones. Further, in S1212, the drone control tower 103 requests the drone 102 for location measurement to change the capturing range.

On the other hand, in a case in which it is determined in S1210 that the arrangement change is not required, the process ends.

Thereafter, the drone control signal generation unit 705 generates drone control signals according to the drone arrangement calculated by the drone arrangement calculation unit 702, and transmits the generated drone control signals to the base station drones, respectively.

<2.3. Hardware Configuration>

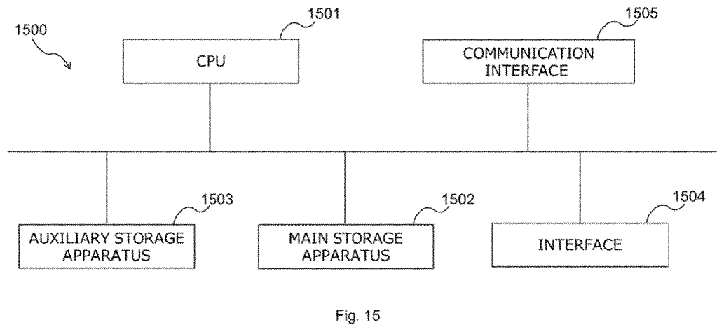

FIG. 15 is a schematic block diagram illustrating an example of a hardware configuration of a computer according to the present example embodiment. The computer illustrated in FIG. 15 may include the base station drone or the drone for location measurement configuring the drone control system according to the present example embodiment. In addition, the computer may operate as the drone control apparatus configuring the drone control tower 103.

A computer 1500 includes a CPU 1501, a main storage apparatus 1502, an auxiliary storage apparatus 1503, an interface 1504, and a communication interface 1505.

Operations of the computer 1500 are stored in the auxiliary storage apparatus 1503 in a form of program. The CPU 1501 reads the program from the auxiliary storage apparatus 1503 and develops the program to the main storage apparatus 1502, and performs, according to the program, operations of each of the apparatuses described in the present example embodiment.

The auxiliary storage apparatus 1503 is an example of a non-transitory tangible medium. Other examples of the non-transitory tangible medium include a magnetic disk, a magneto-optical disk, a compact disk read only memory (CD-ROM), a digital versatile disk read only memory (DVD-ROM), and a semiconductor memory that are connected via the interface 1504. When the program is distributed to the computer 1500 through a communication line, the computer 1500 that has received the distribution may develop the program to the main storage apparatus 1502 and operate according to the program.

Part or all of the constituent elements of each of the apparatuses may be implemented with general-purpose or dedicated circuitry, processor, or the like, or a combination of these. These may be configured of a single chip or may be configured of a plurality of chips connected via a bus. Part or all of the constituent elements may be implemented with a combination of the circuitry or the like and the program described above.

<2.4. Description of Advantageous Effects>

According to the present example embodiment, since the radio waves of the public 5G base stations on the ground are utilized, the introduction cost can be reduced as compared with installing 5G base stations exclusively for the harbor. Further, the radio wave range is determined to correspond to various harbor shapes, and therefore, expertise in network construction is unnecessary. In addition, the range of 5G radio waves can be dynamically changed in accordance with the navigation states of the ships, and the drone control tower can centrally control the respective navigations of the automatic operation ships. Therefore, it is possible to more effectively alleviate traffic congestion, control the order of arrival and departure of ships, and control the entry and leaving of ships.

In another example embodiment, based on the captured data taken by the drone for location measurement, the height of a wave may be also measured at each certain time period in rough weather, and the drone control tower may transmit an alert as a signal to the ship which is highly likely to capsize, based on the fluctuation of the height.

In addition, using the feature of varying the range of 5G radio waves according to the crowding degree, the base station drone may automatically detect, for example during disasters, a place where 5G radio waves do not reach in a densely packed area, and deliver 5G radio waves, which makes it possible to apply this configuration to telemedicine. Furthermore, the example embodiment of the present invention can be applied not only to the harbor but also to landforms surrounded by mountains including places where radio waves of 5G base stations do not reach.

### 3. Second Example Embodiment

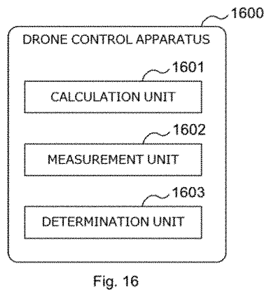

Next, a description will be given of a second example embodiment of the present invention with reference to FIG. 16. The above-described first example embodiment is a concrete example embodiment, whereas the second example embodiment is a more generalized example embodiment.

<3.1. System Configuration>

FIG. 16 is a diagram illustrating a schematic configuration of a drone control apparatus according to a second example embodiment. A drone control apparatus 1600 according to the present example embodiment includes a calculation unit 1601, a measurement unit 1602, and a determination unit 1603.

The calculation unit 1601 calculates a first radio wave range required for navigation of a ship capable of automatic operation, based on a shape of a harbor. The measurement unit 1602 measures a second radio wave range in which a radio wave from a base station on the ground and disposed in the harbor reaches. The determination unit 1603 determines an arrangement of one or more base station drones equipped with a base station function such that a region that is within the first radio wave range and is not included in the second radio wave range is included in a third radio wave range of the one or more base station drones.

Each of the processing units of the apparatus described above is implemented with a central processing unit (CPU) of a computer configured to operate according to a program and a communication interface of the computer, for example. For example, the CPU reads the program from a program recording medium, such as a program storage apparatus of the computer, and uses, as necessary, the communication interface to operate as each of the processing units of the apparatus described above according to the program.

<3.2. Operation Example>

Next, an operation example according to the second example embodiment will be described.

According to the second example embodiment, the drone control apparatus 1600 (calculation unit 1601) calculates the first radio wave range required for navigation of the ship capable of automatic operation, based on the shape of the harbor. The drone control apparatus 1600 (measurement unit 1602) measures the second radio wave range in which the radio wave from the base station on the ground and disposed in the harbor reaches. The drone control apparatus 1600 (determination unit 1603) determines the arrangement of the one or more base station drones equipped with the base station function such that the region that is within the first radio wave range and is not included in the second radio wave range is included in the third radio wave range of the one or more base station drones.

Relationship with First Example Embodiment

As an example, the drone control apparatus 1600 according to the second example embodiment is the drone control tower 103 according to the first example embodiment. In this case, the descriptions of the first example embodiment may also be applicable to the second example embodiment.

The second example embodiment is not limited to this example.

The present invention is not limited to the above-described example embodiments. It should be understood by those of ordinary skill in the art that these example embodiments are merely examples and that various alterations are possible without departing from the scope and the spirit of the present invention.

For example, the steps in the processing described in the Specification may not necessarily be executed in time series in the order described in the corresponding sequence diagram. For example, the steps in the processing may be executed in an order different from that described in the corresponding sequence diagram or may be executed in parallel. Some of the steps in the processing may be deleted, or more steps may be added to the processing.

An apparatus (e.g., one or more apparatuses (or units) out of plurality of apparatuses (or units) constituting the drone control tower, or a module for one of the plurality of apparatuses (or units)) including the constituent elements of the drone control system described in the Specification may be provided. Moreover, methods including processing of the constituent elements may be provided, and programs for causing a processor to execute processing of the constituent elements may be provided. Moreover, non-transitory computer readable recording media (non-transitory computer readable media) having recorded thereon the programs may be provided. It is apparent that such apparatuses, modules, methods, programs, and non-transitory computer readable recording media are also included in the present invention.

The whole or part of the example embodiments disclosed above can be described as in the following supplementary notes, but are not limited to the following.

### (Supplementary Note 1)

A flight vehicle control apparatus including:

calculation means for calculating a first radio wave range required for navigation of a ship capable of automatic navigation using mobile communications, based on a shape of a harbor;

measurement means for measuring a second radio wave range in which a radio wave from a base station on a ground and disposed in the harbor reaches; and

determination means for determining an arrangement of one or more flight vehicles equipped with a base station function such that a region that is within the first radio wave range and is not included in the second radio wave range falls within a third radio wave range of the one or more flight vehicles.

### (Supplementary Note 2)

The flight vehicle control apparatus according to supplementary note 1, wherein the determination means is configured to determine an arrangement of one or more new base station drones in a vicinity of an entrance of the harbor, in accordance with a crowding degree of ships navigating in the vicinity of the entrance of the harbor.

### (Supplementary Note 3)

The flight vehicle control apparatus according to supplementary note 2, wherein the determination means is configured to change a number of one or more flight vehicles to be arranged in the vicinity of the entrance of the harbor, in accordance with a change in the crowding degree.

### (Supplementary Note 4)

The flight vehicle control apparatus according to supplementary note 2, wherein the determination means is configured to change the arrangement of the one or more new flight vehicles arranged in the vicinity of the entrance of the harbor.

### (Supplementary Note 5)

The flight vehicle control apparatus according to any one of supplementary notes 2 to 4, wherein the crowding degree is calculated based on image data taken in the vicinity of the entrance of the harbor.

### (Supplementary Note 6)

The flight vehicle control apparatus according to supplementary note 5, wherein the image data is image data generated to include only a ship capable of automatic navigation from among ships navigating in the vicinity of the entrance of the harbor.

### (Supplementary Note 7)

The flight vehicle control apparatus according to supplementary note 5 or 6, wherein the image data taken in the vicinity of the entrance of the harbor is image data captured by a flight vehicle for location measurement.

### (Supplementary Note 8)

The flight vehicle control apparatus according to any one of supplementary notes 1 to 7, wherein the base station disposed in the harbor includes one or both of a public 5G base station provided by a communication carrier, and a local 5G base station provided in conjunction with a 5G core system.

### (Supplementary Note 9)

The flight vehicle control apparatus according to any one of supplementary notes 1 to 8, wherein the one or more flight vehicles are configured to utilize multi-hop communication.

### (Supplementary Note 10)

A program causing a computer to function as the flight vehicle control apparatus according to any one of supplementary notes 1 to 9.

### (Supplementary Note 11)

A method including:

a calculating step for calculating a first radio wave range required for navigation of a ship capable of automatic navigation using mobile communications, based on a shape of a harbor;

a measuring step for measuring a second radio wave range in which a radio wave from a base station on a ground and disposed in the harbor reaches; and

a determining step for determining an arrangement of one or more flight vehicles equipped with a base station function such that a region that is within the first radio wave range and is not included in the second radio wave range falls within a third radio wave range of the one or more flight vehicles.

This application claims priority based on JP 2020-109729 filed on Jun. 25, 2020, the entire disclosure of which is incorporated herein.

### INDUSTRIAL APPLICABILITY

The present invention can be used as a control system for an automatic navigation ship navigating in a vicinity of a harbor.

### REFERENCE SIGNS LIST

100 Drone Control System
101 Base Station Drone
102 Drone for Location Measurement
103 Drone Control Tower
104 Local 5G Base Station
105 Public 5G Base Station
106 Automatic Operation Ship

What is claimed is:

1. A flight vehicle control apparatus comprising:
one or more memories configured to store an instruction; and
one or more processors configured to execute the instruction to
calculate a first radio wave range required for navigation of a ship capable of automatic navigation using mobile communications, based on a shape of a harbor;
measure a second radio wave range in which a radio wave from a base station on a ground and disposed in the harbor reaches; and
determine an arrangement of one or more flight vehicles equipped with a base station function such that a region that is within the first radio wave range and is not included in the second radio wave range falls within a third radio wave range of the one or more flight vehicles.

2. The flight vehicle control apparatus according to claim 1, wherein the one or more processors are configured to determine an arrangement of one or more new flight vehicles in a vicinity of an entrance of the harbor, in accordance with a crowding degree of ships navigating in the vicinity of the entrance of the harbor.

3. The flight vehicle control apparatus according to claim 2, wherein the one or more processors are configured to change a number of one or more flight vehicles to be arranged in the vicinity of the entrance of the harbor, in accordance with a change in the crowding degree.

4. The flight vehicle control apparatus according to claim 2, wherein the one or more processors are configured to change the arrangement of the one or more new flight vehicles arranged in the vicinity of the entrance of the harbor.

5. The flight vehicle control apparatus according to claim 2, wherein the crowding degree is calculated based on image data taken in the vicinity of the entrance of the harbor.

6. The flight vehicle control apparatus according to claim 5, wherein the image data is image data generated to include only a ship capable of automatic navigation from among ships navigating in the vicinity of the entrance of the harbor.

7. The flight vehicle control apparatus according to claim 5, wherein the image data taken in the vicinity of the entrance of the harbor is image data captured by a flight vehicle for location measurement.

8. The flight vehicle control apparatus according to claim 1, wherein the base station disposed in the harbor includes one or both of a public 5G base station provided by a communication carrier, and a local 5G base station provided in conjunction with a 5G core system.

9. The flight vehicle control apparatus according to claim 1, wherein the one or more flight vehicles are configured to utilize multi-hop communication.

10. (canceled)

11. A method comprising:
calculating a first radio wave range required for navigation of a ship capable of automatic navigation using mobile communications, based on a shape of a harbor;
measuring a second radio wave range in which a radio wave from a base station on a ground and disposed in the harbor reaches; and
determining an arrangement of one or more flight vehicles equipped with a base station function such that a region that is within the first radio wave range and is not included in the second radio wave range falls within a third radio wave range of the one or more flight vehicles.

12. A non-transitory computer-readable recording has recorded a program therein, the program causing a processor to execute:
calculating a first radio wave range required for navigation of a ship capable of automatic navigation using mobile communications, based on a shape of a harbor;
measuring a second radio wave range in which a radio wave from a base station on a ground and disposed in the harbor reaches; and
determining an arrangement of one or more flight vehicles equipped with a base station function such that a region that is within the first radio wave range and is not included in the second radio wave range falls within a third radio wave range of the one or more flight vehicles.
